(19) United States
(12) Patent Application Publication
(10) Pub. No.: US 2013/0187496 A1
(43) Pub. Date: Jul. 25, 2013

(54) ELECTRICAL TERMINAL HOUSING FOR A SUBMERSIBLE PUMP

(71) Applicants: Gary Wayne Creeden, St. Thomas (CA); Thomas M. Scott, Lucas, OH (US); Richard Alan Dankovic, Lexington, OH (US)

(72) Inventors: Gary Wayne Creeden, St. Thomas (CA); Thomas M. Scott, Lucas, OH (US); Richard Alan Dankovic, Lexington, OH (US)

(21) Appl. No.: 13/825,999

(22) PCT Filed: Sep. 30, 2011
(86) PCT No.: PCT/US11/54147

§ 371 Date: Mar. 26, 2013

Related U.S. Application Data
(60) Provisional application No. 61/388,915, filed on Oct. 1, 2010.

(51) Int. Cl. H01R 13/52; H01R 13/523; H01R 43/00

(52) U.S. Cl. CPC H01R 13/5205; H01R 43/00; H01R 13/523
USPC 310/71; 29/876

(57) ABSTRACT

An apparatus and method for connecting an electrical cable having multiple conductors to a submersible pump. A terminal housing defines at least one bore for sealingly engaging a sealing element through which the electrical cable passes. The first sealing element engages the outer jacket of the electrical cable. A gland secured to the terminal housing urges the first sealing element into sealing contact with the terminal housing bore. A second sealing element carried by the housing includes bores for receiving the individual conductors. A pressing element urges the second element into sealing engagement with the terminal housing and the outside surfaces of the conductors. Each individual conductor of a cable terminates in a connector that is releasably connectable to a corresponding mating connector in the submersible pump. The connectors are inter-engageable to form a unitary connector that is easily released from the wiring in the submersible pump.

### RELATED APPLICATION

This application claims the benefit of U.S. Provisional Patent Application Ser. No. 61/388,915, filed on Oct. 1, 2010, the disclosure of which is entirely incorporated herein by reference.

### TECHNICAL FIELD

The present invention relates generally to the connection of power and signal/control cables to a drive motor and, in particular, to a method and apparatus for connecting power/control cables to a submersible pump.

### BACKGROUND ART

Submersible pumps are used for a wide variety of applications. In order to power and monitor a submersible pump, one or more electrical cables must be attached mechanically and electrically to the pump housing. Although an apparatus for making the connection currently exists, there is a need for a connection apparatus and method with improved reliability, including improved sealing to further inhibit the entry of water or other liquid into the motor housing.

### DISCLOSURE OF INVENTION

The present invention provides a new and improved method and apparatus for coupling power and control/signal cables to a submersible pump housing. This disclosed apparatus and method includes multiple sealing components which further inhibit the entry of water from the operating environment, into the motor housing, even if a cable or cables are cut or otherwise mechanically fail.

According to the invention, the electrical terminal assembly is used to connect an electrical cable having multiple conductors to a submersible pump. According to the invention, the terminal housing assembly may be used to connect a power cable to the motor of a submersible pump and/or to connect a control or signal cable to corresponding components such as sensors, also located within the submersible pump housing.

The electrical terminal assembly includes a terminal housing that defines at least one bore. A first sealing element receives the overall electrical cable and includes an element bore that is engageable with an outer jacket of the electrical cable. The first sealing element is receivable and sealingly engageable with the bore defined by the housing. In a more preferred embodiment, the bore is tapered and the sealing element comprises a complementally-shaped bushing.

A gland secured to the terminal housing is operative to urge the first sealing element into sealing contact with the terminal housing bore and the outer jacket of the electrical cable, whereby fluid leakage along the outer jacket of the cable into the terminal housing is inhibited.

A second sealing element is carried by the terminal housing and includes bores for receiving the individual conductors of the electrical cable. A pressing element is operative to urge the second sealing element into sealing engagement with the terminal housing and the outside surfaces of the conductors, whereby fluid leakage into the terminal housing by way of the individual conductors is also inhibited.

The separate sealing of the outer jacket of the overall cable and the individual conductors substantially inhibits fluid leakage into the housing of the submersible pump, even if the outer jacket of the cable is damaged.

According to the illustrated embodiment, the terminal housing defines a second bore for receiving a second electrical cable and includes another set of first and second sealing elements for sealing the outer jacket of the second electrical cable and the individual conductors of the second electrical cable. In practice, one of the electrical cables typically comprises a power cable for providing power to the motor of the submersible pump, whereas the second cable is considered a signal or control cable and transmits control or sensor signals to and from the submersible pump.

In the exemplary embodiment, the pressing element for clamping the second sealing element comprises a spacer having bores that align with the bores formed in the second sealing element. In addition, both the second sealing element and the spacer include aligned bores for a clamping fastener that extends through the aligned bores and threadedly engages the terminal housing. When the fastener is tightened, the second sealing element is sealingly clamped by the spacer and sealingly engages both the terminal housing and the outside surfaces of the individual conductors.

In the preferred and illustrated embodiment, as the gland applies axial forces to the first sealing element or bushing, it co-acts with the tapered bore formed in the terminal housing to cause it to constrict radially inwardly, thus sealingly engaging the outer jacket of the associated serial cable.

According to an additional feature of the invention, the individual conductors of the electrical cable terminate in a quick disconnect connector and corresponding conductors in the submersible pump terminate in a mating quick disconnect connector, whereby the electrical cable can be easily disconnected from the submersible pump when the terminal housing is released from the housing of the submersible pump.

In the illustrated embodiment, a terminal housing assembly is disclosed in which sealing bushings are used to seal the outer jackets of both the power and control cables to the terminal housing. A pair of terminal glands secured by threaded fasteners press the bushings into sealing engagement with the terminal housing and the outer surface of the cables. The individual conductors in the control and powered cables pass through another pair of sealing bushings associated with the cables. The latter sealing bushings are sealingly clamped to the terminal housing by a unitary clamping or spacer element.

According to the preferred method for connecting a multi-conductor cable to a submersible pump, the electrical cable to be connected is passed through a sealing bushing held in a bore defined by a terminal housing. A predetermined length of an outer jacket forming part of the electrical cable is stripped back to expose individual conductors. A gland mounted to the terminal housing is used to apply forces to the sealing bushing in order to urge it into sealing contact with the terminal housing bore and the outer jacket of the electrical cable. The individual conductors are then passed through individual bores in a second sealing bushing. The second bushing is then clamped to the terminal housing using a pressing element or a spacer that urges the second sealing bushing into sealing contact with the terminal housing and the outer surfaces of each of the individual conductors. The terminal housing is then sealing attached to a pump housing forming part of the submersible pump.

To further facilitate replacement of the electrical cable when needed, the individual conductors in the cable terminate in a quick disconnect-type connector and the corresponding conductors in the submersible pump are terminated in a mating quick disconnect connector. With the disclosed invention, replacement of the cable involves removal or release of the terminal housing from a submersible pump (after the pump is removed from its operating environment) and the quick disconnect connector portions are separated, thus facilitating replacement of a damaged or failed electrical cable with a replacement cable having the terminal housing already attached.

With the disclosed invention, a first seal is used to seal the outer jacket of a cable to the housing and a second seal seals the conductors of a cable to a housing. This dual sealing arrangement further inhibits the entry of water into the pump motor housing. The disclosed terminal housing assembly also facilitates the repair or replacement of the power cable/control cable connection to the submersible pump.

Additional features of the invention will become apparent and a fuller understanding obtained by reading the following detailed description made in connection with the accompanying drawings.

### BRIEF DESCRIPTION OF DRAWINGS

FIG. 1 is a perspective view of a terminal housing assembly constructed in accordance with a preferred embodiment of the present invention;

FIG. 2A is a sectional view of the terminal housing assembly;

FIG. 2B in an exploded view, partially in section, of the terminal housing assembly shown in FIG. 1;

FIG. 3 is a diagram showing connections of the electrical cables shown in FIG. 1 as well as quick disconnect connectors in which the individual conductors of the cable terminate;

FIG. 4 illustrates a typical cable construction that is connected to a submersible pump by the terminal housing;

FIGS. 5A-5G illustrate the construction of a terminal housing forming part of the terminal housing assembly shown in FIG. 1;

FIGS. 6A-6C illustrate the construction of a spacer forming part of the terminal housing assembly shown in FIG. 1;

FIGS. 7A-7C illustrate a bushing that forms part of the terminal housing shown in FIG. 1;

FIGS. 8A-8C illustrate the construction of another bushing forming part of the terminal housing assembly shown in FIG. 1;

FIGS. 9A-9C illustrate a terminal gland that forms part of the terminal housing assembly shown in FIG. 1;

FIGS. 10A-10C illustrate another terminal gland forming part of the terminal housing assembly shown in FIG. 1;

FIGS. 11A-11C illustrate another bushing that forms part of the terminal housing assembly shown in FIG. 1;

FIGS. 12A-12C illustrate the construction of another bushing that forms part of the terminal housing assembly shown in FIG. 1; and

FIG. 13 is a perspective view of a submersible pump showing attachment of power and control cables to the pump by means of the terminal housing assembly shown in FIG. 1.

### BEST MODE FOR CARRYING OUT THE INVENTION

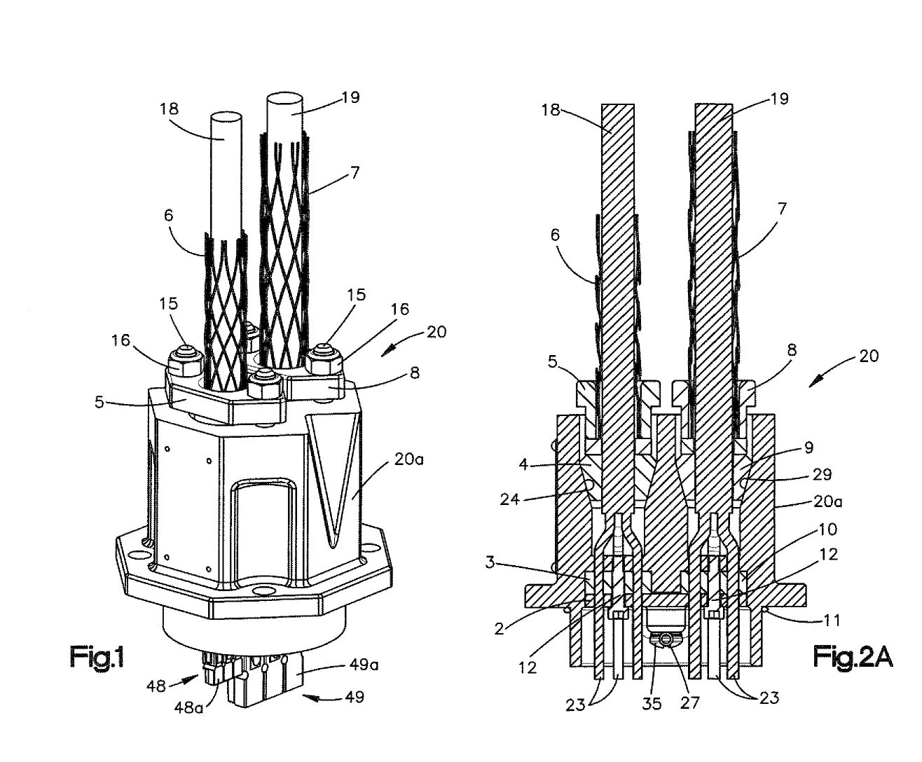

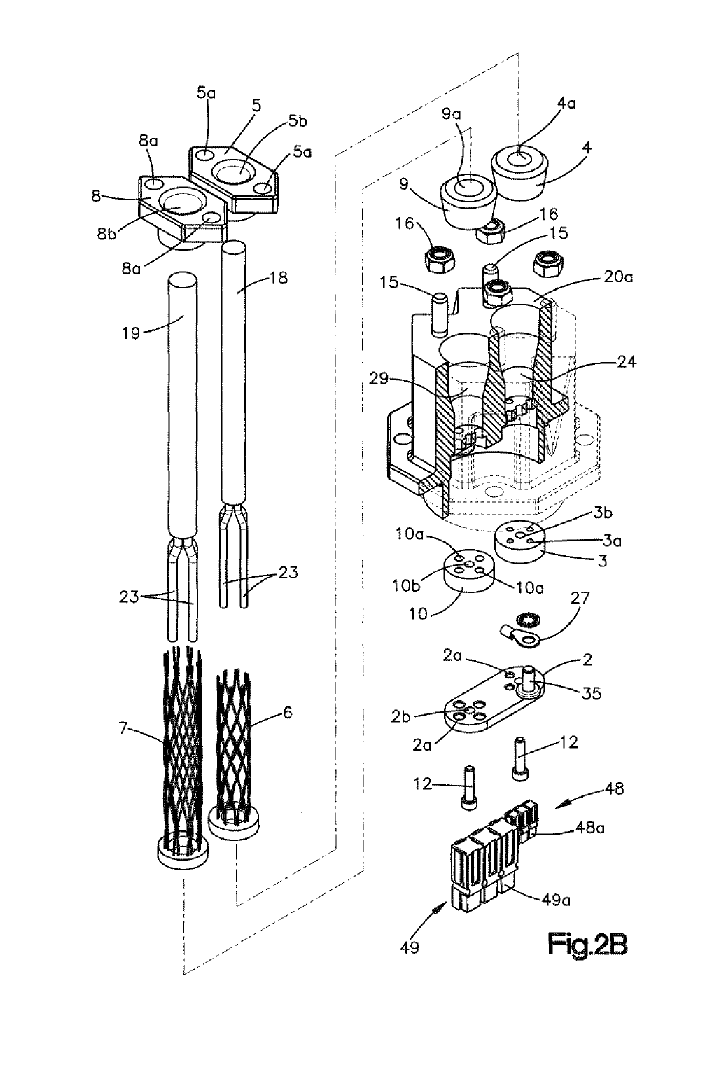

FIGS. 1, 2A and 2B illustrate the overall construction of a terminal housing assembly 20 constructed in accordance with a preferred embodiment of the invention. The terminal housing assembly 20 of the present invention is used to connect one or more electrical cables to a submersible pump. In the illustrated embodiment, the terminal housing is used to connect a signal or control cable 18 and a power cable 19 to a submersible pump P such as that shown in FIG. 13.

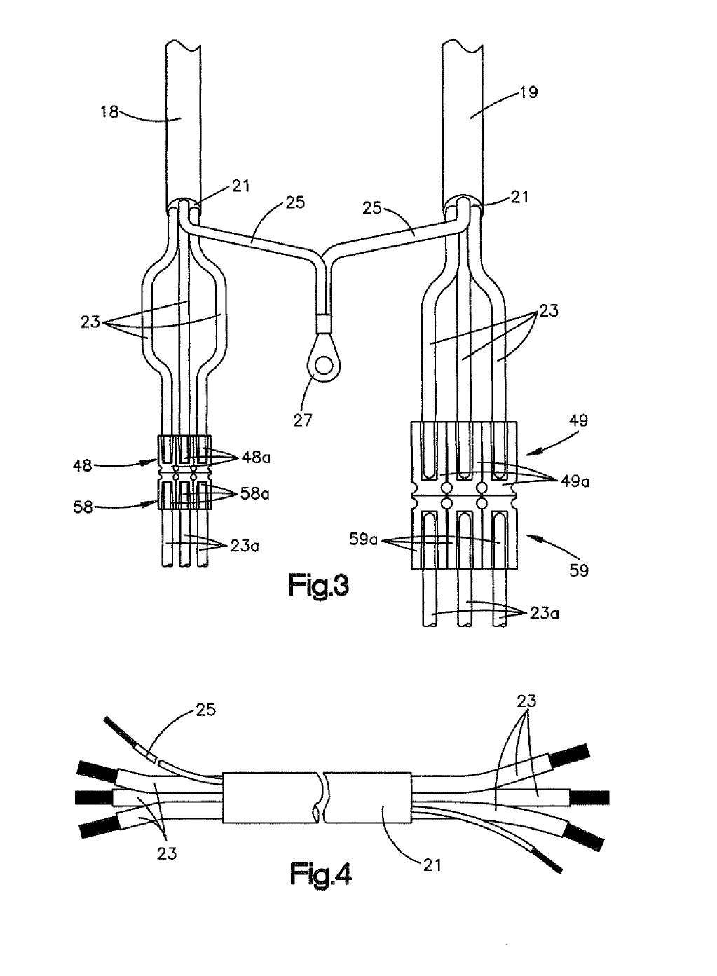

Cables 18 and 19 both contain multiple conductors. Each cable has an outer jacket 21 (Shown best in FIGS. 3 and 4) that provides protection for a number of conductors 23 (see FIG. 4). Each individual conductor has its own layer of insulation. The number of conductors may vary in each cable. An example of a cable used for this purpose is illustrated in FIG. 4.

As seen in FIG. 4, the illustrated cable includes the outer jacket 21 and three conductors labeled 23. If the cable shown in FIG. 4 represents the power cable 19, the three individual conductors 23 provide power to the pump motor forming part of the submersible pump. As is known, an electric motor operating at 240 volts AC, require three wires. The fourth wire illustrated in FIG. 4 would be considered a separate ground wire 25.

If the cable shown in FIG. 4 represents the single control cable 18, the three conductors 23 represent control or signal carrying wires. The control cable 18 also preferably includes a ground cable 25.

As seen in FIG. 3, when two or more cable are connected to the submersible pump through the terminal housing 20a, the individual ground cables 25 from each electrical cable 18, 19 are joined to a single terminal 27.

It is also contemplated that cables 18 and 19 could be combined into one single cable, with all of the conductors inside of one outer jacket. While this might simplify the number of parts, it would make the cable stiffer and might add additional cost to the product. There may be other advantages or disadvantages of using a single cable instead of two.

It is also conceived that in some cases a single submersible pump might require more than one complete terminal housing subassembly 20. This could be due to the amount of electrical current or the type of voltage required to operate the pump or other possible causes.

Power cable 19 is what carries the actual current required to the submersible pump motor in order to power it. Control cable 18 connects to multiple sensors within the pump to provide feedback to a conventional motor control panel (mounted above the water surface—not shown) to give indication of whether there is a fault within the unit. Any such fault would trigger the control panel to terminate sending current through the power cable 19. Some of the sensors contemplated to be connected to the control cable include moisture detection and thermal readings. Other sensors could be used in addition to these or in place of these.

The sealing arrangement for both the power cable 19 and the control cable 18 may be substantially identical other than the number of individual conductors.

Prior to assembly, the power cable 19 and the control cable 18 have their outer jackets stripped off a predetermined length from their respective ends. Each individual conductor 23, 25 is then also stripped a predetermined length from their ends (see FIG. 4).

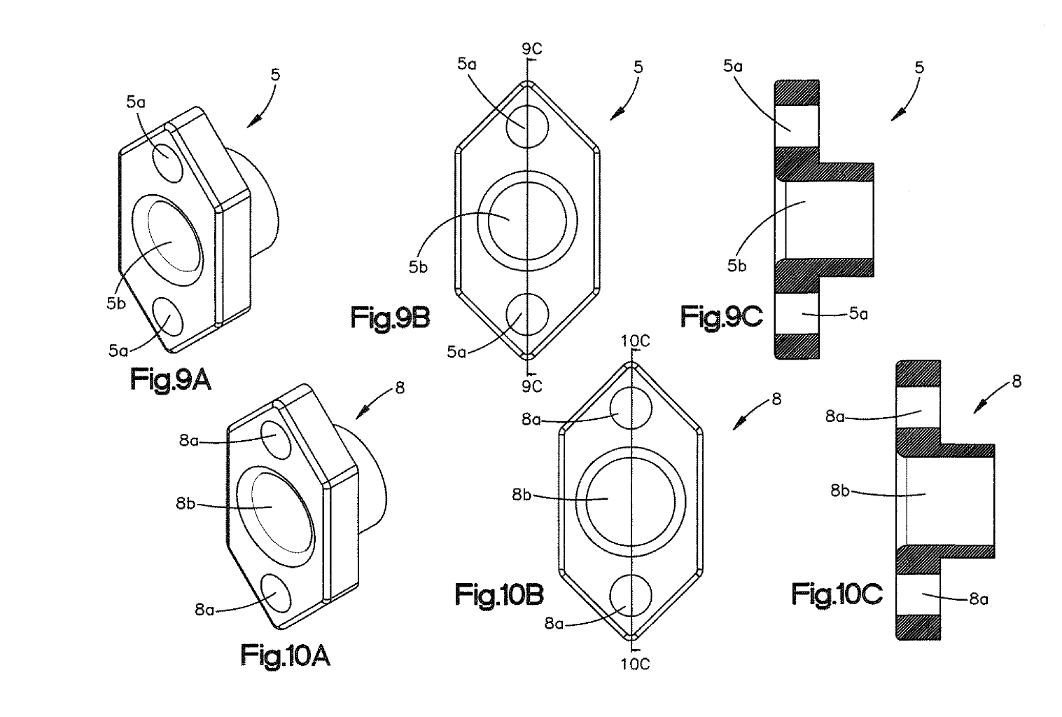

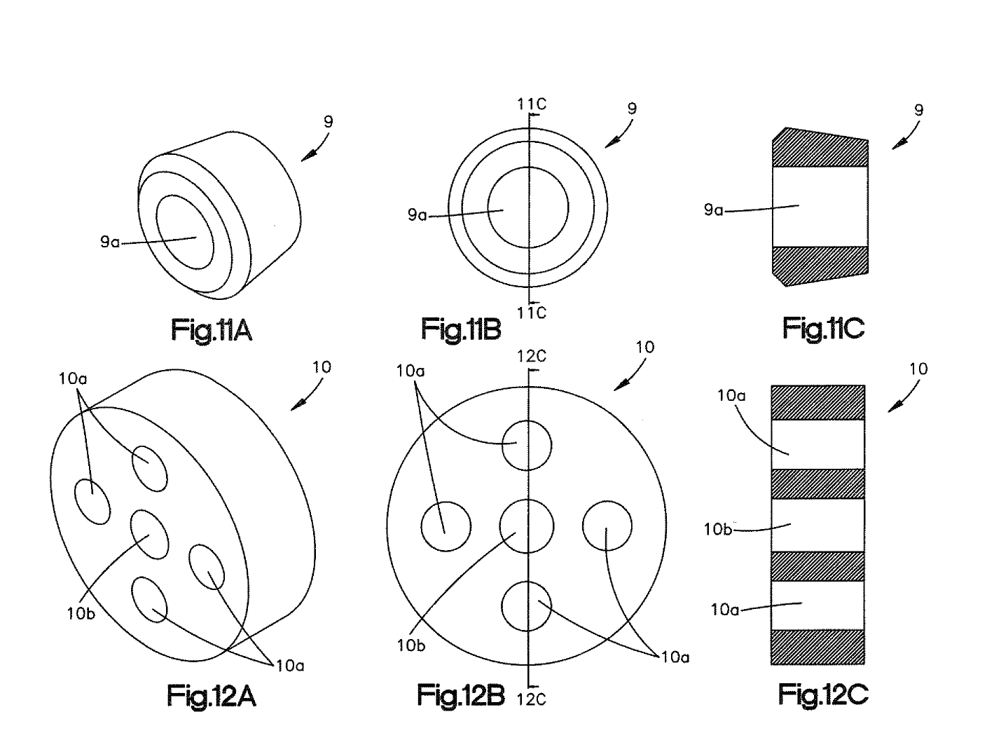

The next step in the assembly procedure would be to slide the terminal glands 5 (see also FIGS. 9A-9C) and 8 (see also FIGS. 10A-10C) over the respective cables, oriented as shown in FIGS. 1, 2A, 2B. Next, cable grips 6 and 7 would be slid onto their respective cables as shown best in FIG. 2B. The cables 18, 19 slide through respective bores 5b, 8b in glands 5, 8. Bushings 4 (see also FIGS. 8A-8C) and 9 (see also FIGS. 11A-11C) would then be installed on the cables such that the respective inner diameters 4a, 9a of the bushings slide over the outer jackets 21 of their respective cables.

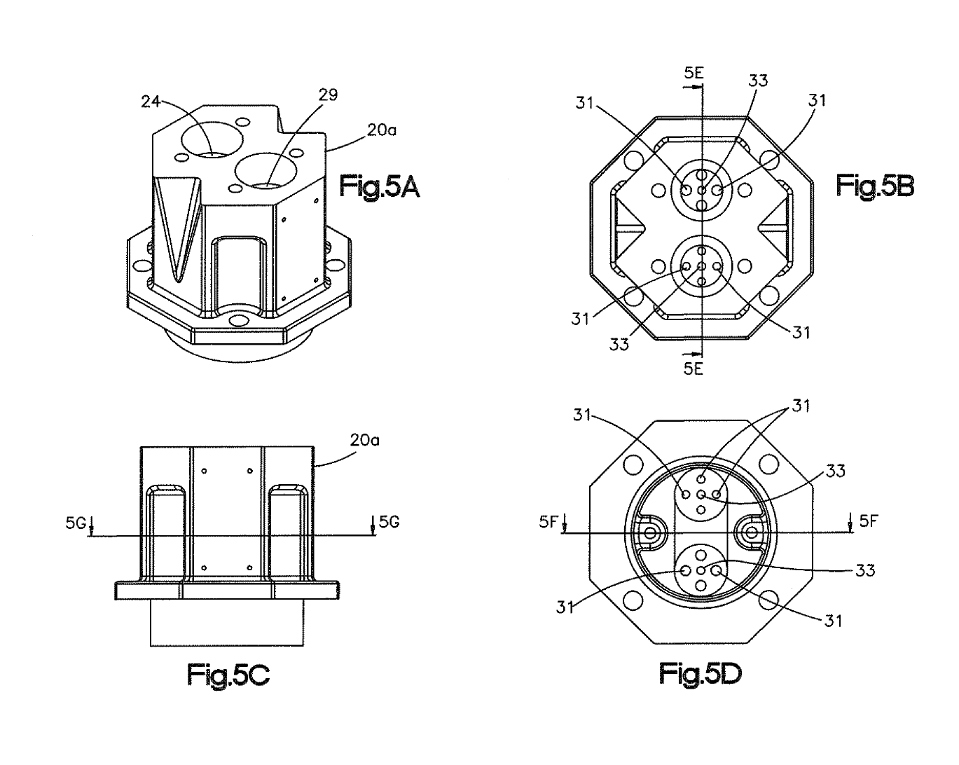

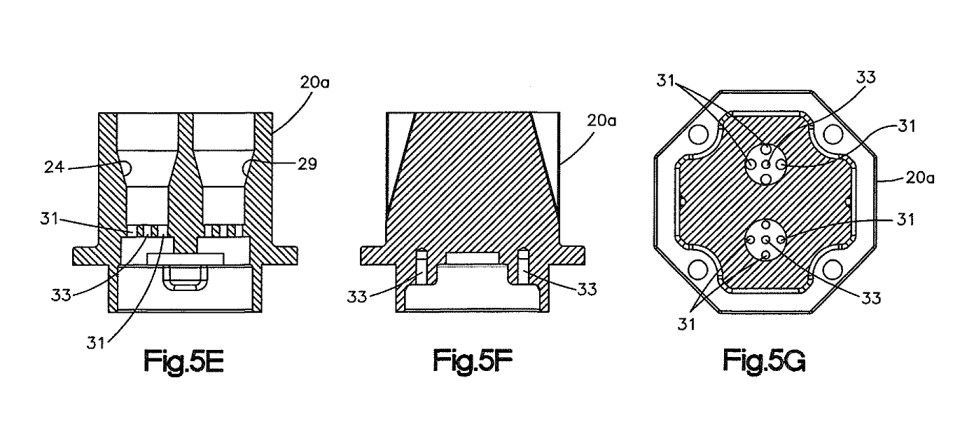

Referring to FIGS. 1, 2A, 2B, power cable 19 and control cable 18 are then installed into a terminal housing 20a (see also FIGS. 5A-5G) as shown, by pulling the stripped conductors through from the top of the terminal housing 20a. Preinstalled in the terminal housing are studs 15. Terminal glands 5 and 8 have respective through holes 5a, 8a to be aligned with the studs 15. As nuts 16 are tightened on studs 15, terminal glands 5 and 8 press against cable grips 6 and 7 which press bushings 4 and 9 until they conform to the tapered bores 24, 29 of terminal housing 20a (see also FIG. 5E). It is conceived these bores would not need to be tapered, but rather could be straight or of some other shape. It is also conceived that the inner diameters 4a, 9a of the bushings 4 and 9 could be such that they are either tight or loose on the outer diameter of the power cable 19 and control cable 18 outer jackets prior to the nuts 16 being tightened down on the studs 15. Once the nuts 16 are tight, the bushings 4 and 9 seal along both the outer jackets 21 of the cables 18 and 19 and also along the respective bores 24, 29 of the terminal housing 20a, preventing any liquid from entering into the terminal housing 20a or motor housing of the submersible pump P (FIG. 3). Alternately, the studs 15 and nuts 16 could be replaced by capscrews or clamped down by another alternate method.

Referring to FIGS. 2b, 5b and 5d, the individual conductors 23, 25 are fed through bores 31 formed in the terminal housing. The terminal housing 20a may be formed with multiple sets of these bores, depending on how many cables will be connected to the submersible pump by the housing. In the illustrated embodiment, the terminal housing defines two sets of bores, one set being used by the conductors of the cable 18, whereas the other sets of bores used for the conductors of the cable 19. The terminal 27 that joins the ground wires 25 (FIG. 3) is attached to the terminal housing 20a by a suitable fastener 35.

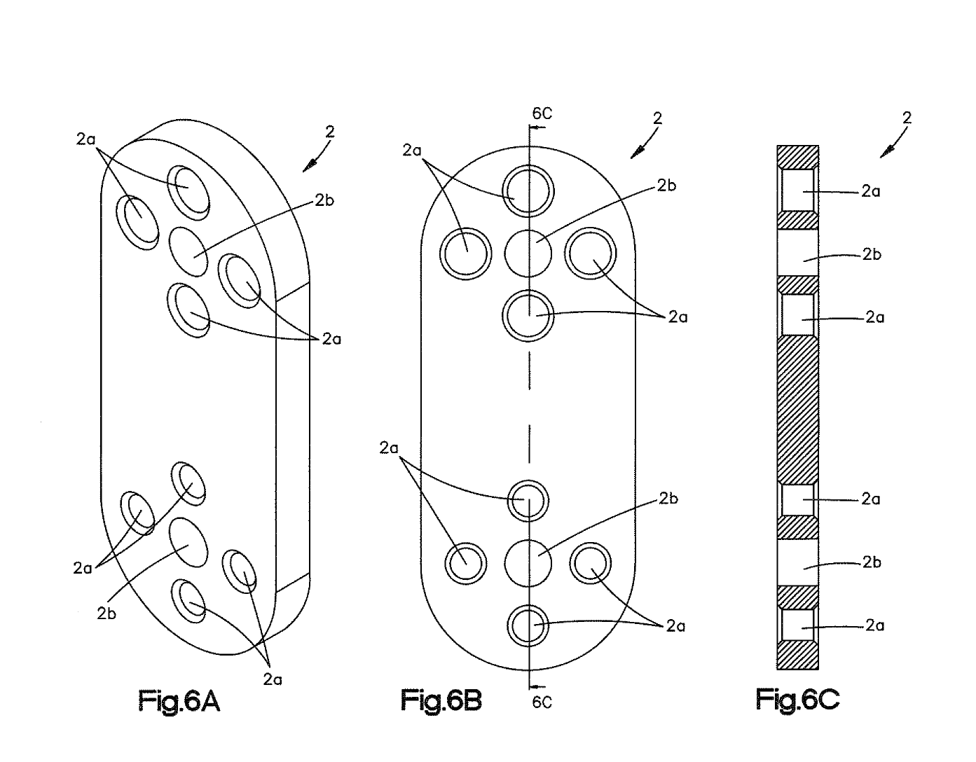

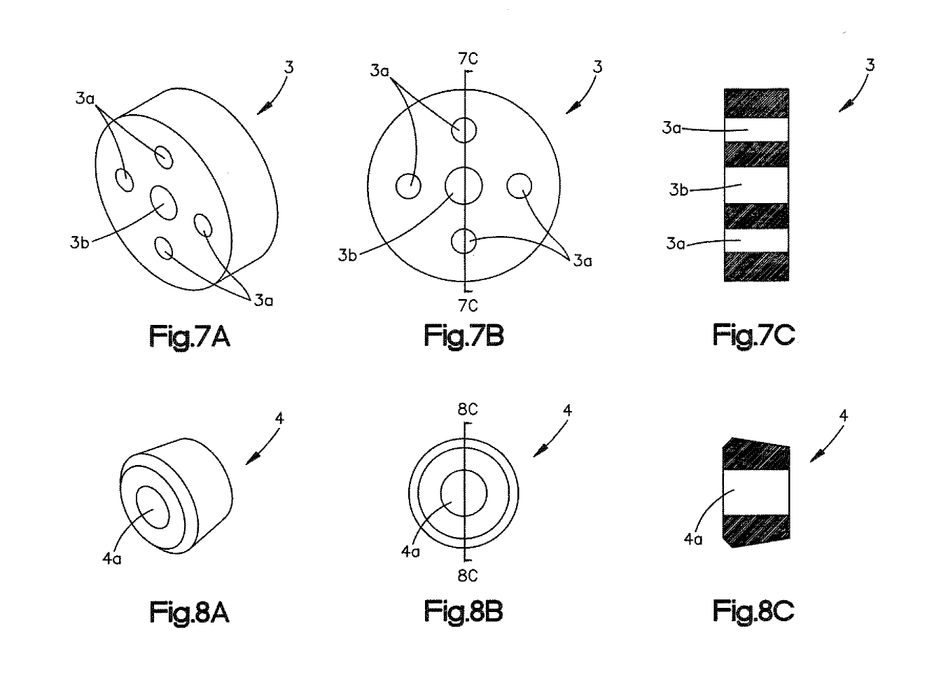

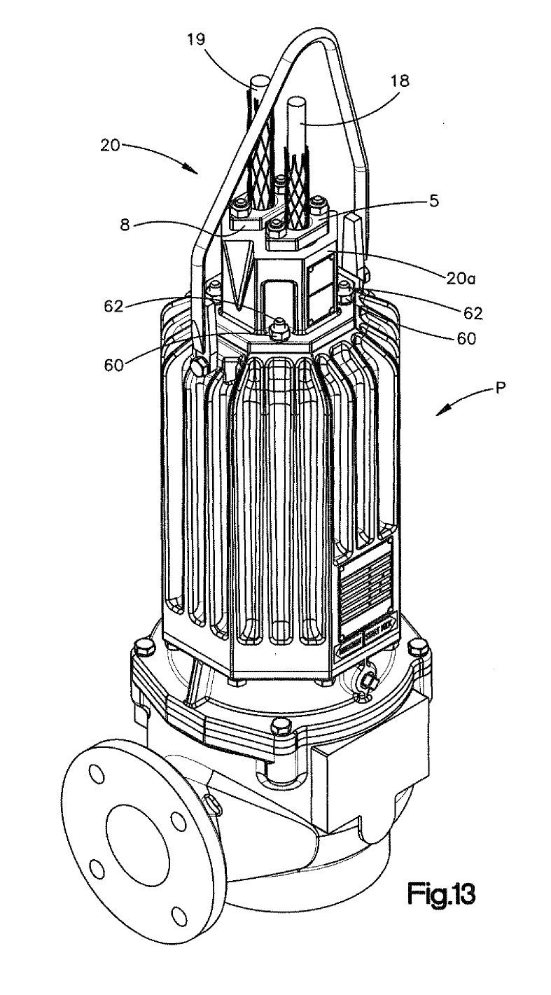

The individual conductors 23, 25 of the power cable 19 and control cable 18 are then fed through bushings 3 (see also FIGS. 7A-7C) and 10 (see also FIGS. 12A-12C) and are pressed against the terminal housing 20a. The individual conductors pass through respective bores 3a, 10a formed in the bushings 3, 10. A one piece spacer 2 (see also FIGS. 6A-6C) is then installed against bushings 3 and 10 with the individual conductors from the power cable 19 and the control cable 18 fed through individual holes 2a in the one piece spacer 2. Socket head screws 12 are then used to tighten the one piece spacer 2 against the bushings 3 and 10 to force the bushings 3 and 10 to seal against the terminal housing 20a and the insulation on the individual conductors from the power cable 19 and the control cable 18. The screws 12 extend through associated bores 2b, 3b, 10b formed in the spacer 2 and the bushings 3, 10, respectively and threadedly engage the threaded bores 33 formed in the terminal housing 20a. The reason for these additional bushings 3 and 10 is that in some field installations the outer jacket on the power cable 19 or control cable 18 could be accidentally cut or damaged, allowing moisture to enter the inside of the outer jacket. If that occurs, leakage could make it past the first set of bushings 4 and 9. The sealing along the insulation of the individual conductors with bushings 3 and 10 prevents the leakage from escaping below the one piece spacer 2. It is contemplated that screws 12 could be replaced by other methods of fastening.

The bushings 3, 4, 9, 10 are preferably made from an elastomer. Examples of elastomers that are contemplated include, but are not limited to, neoprene rubber or a fluorinated elastomer such as Dupont Viton or equivalent. It should be noted here that the spacer 2, the bushings 3, 10 and the housing 20a are shown with sets of four bores (2a, 3a, 10a, 31) equally spaced about a center bore. The number of bores spaced about the center bore may vary depending on the number of conductors in the control and power cables 18, 19. With some applications, less than four conductor bores may be needed, whereas in other application, more than four bores will be required.

Terminal housing 20a is installed onto the submersible motor housing with a nut 60 and stud 62 arrangement (shown in FIG. 13) or other methods of fastening. O-ring 11 is installed between the terminal housing 20a and the motor housing, preventing any moisture from entering the motor housing from below the terminal housing 20a. Alternately o-ring 11 could be replaced with a gasket.

Prior to installing the terminal housing to the motor housing as described above, the stripped ends of the individual conductors 23, 25 from the power cable 19 and the control cable 18 are installed into respective cable connectors 49, 48 as shown in FIG. 3. The number of leads and individual connections can vary based upon several factors including voltage, power ratings and type of control/sensors used. Mating cable connectors 58, 59 are installed on the conductor leads (the lower set of wires shown in FIG. 3) of the motor windings or sensors (not shown), In the preferred embodiment, each individual conductor terminates in an individual connector 48a, 49a. The connectors 48a, 49a, however, are of the type that can be inter-engaged in a side-by-side relationship to form a unitary connector assembly 48, 49 for a given cable. In the preferred embodiment, the connectors 58, 59 are similarly constructed and include inter-engageable connector elements 58a, 59a for each conductor 23a. With the disclosed construction, the individual conductors of a given cable are simultaneously disconnected from the corresponding wires in the submersible pump and do not have to be individually disconnected, thus facilitating replacement of the cable. The cable connectors are typically color coded. This connection makes field retrofit of a damaged cable/terminal housing much simpler than any existing designs on the market today. The connectors shown in FIG. 3 are available from Anderson Power Products of Sterling, Mass.

In the preferred and illustrated embodiment, the terminal housing 20a is constructed of cast iron. Other metal materials or non-metal materials for the terminal housing 20 are contemplated by the invention.

With the disclosed invention, the integrity and reliability of the electrical connections to a submersible pump are greatly improved. Moreover, serviceability is also improved. By providing separate seals for the overall cable and the individual conductors, leakage into the motor housing of the submersible pump is substantially inhibited. Serviceability is improved because the replacement of a damaged or failed cable can be easily accomplished by simply removing the submersible pump from its sump, releasing the terminal housing from the pump housing and then separating the connectors 48, 49. The invention contemplates providing a length of cable with one end already attached to the terminal housing and with the individual conductors attached to the connectors 48, 49. With this configuration, the replacement cable with terminal housing attached is simply coupled to the connectors 58, 59, forming part of the submersible pump, followed by attachment of the terminal housing to the submersible pump housing by means of the nuts 60 and the studs 62 (shown in FIG. 13).

It should also be noted here that the invention contemplates, as indicated above, multiple terminal housings mounted to a given pump to accommodate multiple power and control/signal cables. Those skilled in the art will recognize that the principles of the invention can be applied to construct a terminal housing for attaching three or more electrical cables to a submersible pump

Although the invention has been described with a certain degree of particularity, it should be understood that those skilled in the art can make various changes to it without departing from the spirit or scope of the invention as hereinafter claimed.

Having described the invention, the following is claimed:

1. An electrical terminal assembly for connecting an electrical cable having multiple conductors to a submersible pump, comprising:
a) a terminal housing defining at least one bore and said terminal housing releasably attached to said submersible pump;
b) a first sealing element for receiving said electrical cable and including an element bore engaging an outer jacket of said electrical cable, said first sealing element receivable and sealingly engageable with said terminal housing bore;
c) a gland secured to said terminal housing and operative to urge said first sealing element into sealing contact with said terminal housing bore and said outer jacket of said electrical cable;
d) a second sealing element carried by said terminal housing and including bores for receiving said individual conductors of said electrical cable;
e) a pressing element operative to urge said second sealing element into sealing engagement with said terminal housing and the outside surfaces of said conductors.

2. The terminal assembly of claim 1 wherein said terminal housing defines a second bore for receiving a second electrical cable and further includes another first sealing element and another second sealing element for sealing the outer jacket of said second electrical cable and individual conductors of said second electrical cable, respectively, to said terminal housing, whereby fluid leakage into said terminal housing along an outer jacket of said electrical cable and said individual conductors is inhibited.

3. The terminal housing of claim 1 wherein said gland is held to said housing by threaded fasteners.

4. The apparatus of claim 1 wherein said second sealing element and said pressing element have aligned bores for receiving a fastener that is threadedly engageable with said terminal housing and which applies pressing forces to said pressing element whereby said second sealing element is sealingly clamped between said pressing element and said terminal housing.

5. The terminal housing of claim 1 wherein said bore is tapered and said gland urges said first sealing element in an axial direction, whereby said sealing element co-acts with said tapered bore in order to constrict said sealing element in a radial direction whereby said sealing element sealingly engages said tapered bore and said outer jacket of said electrical cable.

6. The apparatus of claim 1 wherein terminal ends of said individual conductors terminate in a quick disconnect connector and corresponding conductors in said submersible pump terminate in a mating quick disconnect connector, whereby said electrical cable can be easily disconnected from said submersible pump after said terminal housing is released from said submersible pump.

7. A method for connecting a multi-conductor cable to a submersible pump, comprising the steps of:
a) passing said electrical cable through a first sealing bushing held in a bore defined by a terminal housing;
b) stripping back a predetermined length of an outer jacket of said electrical cable to expose individual conductors in said cable;
c) using a gland mounted to said terminal housing to apply forces to said first sealing bushing to urge it into sealing contact with said terminal housing bore and said outer jacket of said electrical cable;
d) passing said individual conductors through individual bores in a second sealing bushing;
e) clamping said second bushing to said terminal housing using a pressing element that urges said second sealing bushing into sealing contact with said terminal housing and outer surfaces of each of said individual conductors; and
f) sealingly attaching said terminal housing to a pump housing forming part of said submersible pump.

8. The method of claim 7 further comprising the step of terminating the individual conductors of said electrical cable in a quick disconnect type connector and terminating corresponding conductors in said submersible pump in a mating quick disconnect connector.

9. The terminal housing of claim 1 wherein said electrical cable comprises a power cable.

10. The terminal assembly of claim 1 wherein said electrical cable comprises a signal cable.

11. The terminal assembly of claim 2 wherein one of said electric cable comprises a power cable and the other electrical cable comprises a signal cable that includes individual conductors, at least some of which are connectable to a sensor forming part of said submersible pump.

12. The terminal assembly of claim 1 wherein said terminal housing is releasably attached and sealingly engaged with a housing of said submersible pump.

13. The terminal assembly of claim 1 further comprising a cable grip surrounding a portion of said outer jacket, said cable grip held in position by said gland.

14. The method of claim 7 further comprising the step of installing a cable grip near an end of said electrical cable prior to passing said electrical cable through said first sealing bushing.

15. An electrical terminal assembly for connecting an electrical cable having multiple conductors to a submersible pump, comprising:
a) a terminal housing releasably attached to a submersible pump;
b) said terminal housing receiving and sealingly engaging said electrical cable;
c) each of said conductors of said electrical cable extending from said terminal housing and terminating in a connector, releasably connectable to a corresponding mating connector in said submersible pump;
d) said connectors being co-engageable with each other to form a unitary connector for said individual conductors.

16. The terminal assembly of claim 15 further including:
a) a sealing element for receiving said electrical cable, including an element bore engageable with the outer jacket of said electrical cable;
b) said terminal housing defining at least one bore sealingly engageable with said sealing element.

17. The terminal assembly of claim 16 further comprising a second sealing element carried by the terminal housing an including bores for receiving said individual conductors of said electrical cable and a pressing element operative to urge said second sealing element into sealing engagement with said terminal housing and the outer surfaces of said conductors.
